(19) United States
(12) Patent Application Publication
(10) Pub. No.: US 2004/0027721 A1
(43) Pub. Date: Feb. 12, 2004

(54) Disk cartridge and disk drive therefor

(75) Inventor: Fumihito Imai, Odawara-shi (JP)

Correspondence Address: SUGHRUE MION, PLLC, 2100 PENNSYLVANIA AVENUE, N.W., WASHINGTON, DC, 20037, US

(73) Assignee: FUJI PHOTO FILM CO., LTD.

(21) Appl. No.: 10/631,865

(22) Filed: Aug. 1, 2003

(30) Foreign Application Priority Data
Aug. 6, 2002 (JP) 228256/2002

(51) Int. Cl. G11B 23/03

(52) U.S. Cl. 360/133

(57) ABSTRACT

In a disk cartridge provided with a rotary shutter, the incorporating suitability of the disk cartridge and the processability of the rotary shutter are improved by removing a coil spring and a guide wire which urge the rotary shutter to a closed position. A coil spring is removed, and a shutter knob 7b of the rotary shutter 7 engages with shutter closing means to lead the rotary shutter 7 to the closed position when ejecting the disk cartridge from a disk drive. The shutter closing means is constituted of an elastic member and provided in the disk drive.

### BACKGROUND OF THE INVENTION

1. Field of the Invention

The present invention relates to a disk cartridge in which a discoid recording medium is rotatably contained in a housing and which is inserted into a slot provided in a disk drive to be placed in the disk drive, and to a disk drive therefor.

2. Description of the Related Art

Recording media, e.g., a micro-magnetic disk cartridge called clik! (registered trademark) have been conventionally used for mobile equipment such as digital cameras.

FIGS. 6(a) to 6(c) are a plan view, a right side view and a bottom plan view showing a closed rotary shutter 7 of a magnetic disk cartridge 1, respectively. FIGS. 7(a) and 7(b) are a plan view and a bottom plan view showing the opened rotary shutter 7, respectively. As shown in these Figures, a flat housing of the magnetic disk cartridge 1 rotatably contains a magnetic disk 5. The flat housing is constituted of a resin frame 2 which includes a pressing portion 2a, and upper and lower shells 3 and 4 which are made of thin metal plate. The dimensions of the housing are 50 mm wide by 55 mm deep by 1.95 mm thick. The magnetic disk 5 has a storage capacity of 40 MB and a diameter of 1.8 inches (45.7 mm).

The magnetic disk cartridge 1 is constituted to be inserted and placed in a disk drive 20 as shown in FIG. 9. A V-shaped opening 6 and the rotary shutter 7 are provided in the housing. The opening 6 is for a magnetic head 27 of the disk drive 20 to access the surface of the magnetic disk 5, and the rotary shutter 7 opens and closes the opening 6.

In addition, a notch 8 is formed in the top portion on the left side of the housing. The notch 8 ensures the positioning in the disk drive 20 by engaging with an engaging member 29 located in the disk drive 20. A small window 9 is formed in the top portion on the right side so that a shutter locking member 11 which locks the rotary shutter 7 at a closed position faces outside.

A circular opening 4a and a groove 4b are formed in the lower shell 4 of the housing. The opening 4a is for fitting a spindle 23 of the disk drive 20 to a center core 10 of the magnetic disk 5. The groove 4b is concentric with the rotary shutter 7 and extended circularly over a predetermined angle range. A shutter knob 7b is attached to the rotary shutter 7. The shutter knob 7b protrudes from the arcuate groove 4b and moves along the arcuate groove 4b to open and close the rotary shutter 7.

FIGS. 8(a) and 8(b) are plan views showing the closed and opened rotary shutter 7 by removing the upper shell 3 and omitting the magnetic disk 5, respectively.

A convex engaging portion 11a which can be inserted into a concave engaging portion 7c formed on the periphery of the rotary shutter 7 is provided on the tip of a shutter locking member 11. The shutter locking member 11 which locks the rotary shutter 7 at a closed position is rotatably attached to a shaft 12 provided in the housing. The shutter locking member 11 is urged by a spring plate 11b to a direction where the convex engaging portion 11a can be inserted into the concave engaging portion 7c (counterclockwise direction in FIG. 8). The shutter locking member 11 is constituted as follows: when the magnetic disk cartridge 1 is inserted into the disk drive 20, a lock releasing member 19 provided in the disk drive 20 passes through the small window 9 to press the shutter locking member 11; accordingly, the locking member 11 is slightly rotated clockwise, and the convex engaging portion 11a escapes from the concave engaging portion 7c; thus the lock on the rotary shutter 7 is released.

The rotary shutter 7 is urged by a thin long coil spring 14 with a small diameter to a closing direction (counterclockwise direction in FIG. 8). To attach this coil spring 14, a guide wire 13 is provided. One end of the guide wire 13 is fixed to a frame 2 at a portion 2b which faces the periphery of the rotary shutter 7. The other end slidably penetrates a supporting member 7d fastened to the periphery of the rotary shutter 7 and extends along the periphery of the rotary shutter 7.

As shown in FIG. 8(a), the coil spring 14 is compressed and attached between the portion 2b of the frame 2 and the supporting member 7d to expand and compress along the guide wire 13. The coil spring 14 urges the rotary shutter 7 to the closing direction (counterclockwise direction in FIG. 8). When the rotary shutter 7 released from the lock is rotated clockwise in FIG. 8 from this state, the coil spring 14 is compressed as shown in FIG. 8(b).

The disk drive 20 shown in FIG. 9 is a Type II PC card drive which has the dimensions of 53 mm wide by 85 mm deep by 5 mm thick. The disk drive 20 includes a slot 21, a spindle motor 22, a head actuator 24, a swing arm 25 and a head suspension 26. The disk cartridge 1 is inserted into the slot 21. The spindle motor 22 is provided with a spindle 23 which magnetically attracts the center core 10 of the magnetic disk 5. The head suspension 26 is supported by the swing arm 25. On the tip of the head suspension 26, a magnetic head 27 is disposed to access the surface of the rotating magnetic disk 5 to record and reproduce information.

The disk drive 20 further includes a push-push cartridge engaging/releasing mechanism 28 and an input/output interface 30. The mechanism includes the engaging member 29 which engages with a notch 8 of the magnetic disk cartridge 1. The input/output interface 30 is for electronic equipment such as digital cameras and personal computers to which this disk drive 20 is installed.

Inside the slot 21 of the disk drive 20, an engaging wall 18 which bilaterally extends to be orthogonal to an insertion direction of the magnetic disk cartridge 1 is formed on the right side as shutter opening means. A lock releasing member 19 is also provided to release the rotary shutter 7 locked at the closed position when inserting the magnetic disk cartridge 1.

When the magnetic disk cartridge 1 is inserted into the slot 21 of the disk drive 20, first, the lock releasing member 19 presses the shutter locking member 11 to release the lock on the rotary shutter 7, and the shutter knob 7b engages with the engaging wall 18 under that condition. Accordingly, accompanying the insertion of the magnetic disk cartridge 1, the rotary shutter 7 is rotated compressing the coil spring 14 as the shutter knob 7b slides along the engaging wall 18. Consequently, the rotary shutter 7 is opened as shown in FIGS. 7(a) and 7(b) and FIG. 8(b). Simultaneously, the engaging member 29 of the disk drive 20 engages with the notch 8 of the magnetic disk cartridge 1. As shown in FIG. 8(b), the magnetic disk cartridge 1 is loaded to a predetermined position in the disk drive 20 while the coil spring 14 is still compressed.

By contrast, when ejecting the magnetic disk cartridge 1, the cartridge engaging/releasing mechanism 28 pushes out the magnetic disk cartridge 1 by pressing the pressing portion 2a of the magnetic disk cartridge 1. Moreover, accompanying the ejection of the magnetic disk cartridge 1, the coil spring 14 urges the rotary shutter 7 so that the rotary shutter 7 is rotated to the closed position shown in FIGS. 6(a) and 6(c) and FIG. 8(a) and locked by the shutter locking member 11.

Incidentally, in the foregoing conventional magnetic disk cartridge 1, a long coil spring 14 which expands and compresses along the guide wire 13 has been employed as means for urging the rotary shutter 7 toward the closed position in order to securely operate the rotary shutter 7, as apparent from FIG. 8(a). Nevertheless, it has been difficult to incorporate the guide wire 13 and the long coil spring 14 into the housing of the magnetic disk cartridge 1. Moreover, a support member 7d with a complicated shape has been required to be provided in the rotary shutter 7, and thus it has been difficult to process the rotary shutter 7d.

### SUMMARY OF THE INVENTION

In consideration of the aforementioned circumstances, a first object of the present invention is to provide a magnetic disk cartridge in which the incorporating suitability and the processability thereof is improved without including a coil spring or a guide wire.

A second object of the present invention is to provide a disk drive which is suitable for placing a magnetic disk cartridge of the present invention thereinto.

The first invention of this application is a disk cartridge in which a discoid recording medium is rotatably contained in a housing and which is inserted into a slot formed in a disk drive to be placed in the disk drive.

The housing includes an opening, a rotary shutter and locking means. The opening is for a read/write head of the disk drive to access the surface of the recording medium. The rotary shutter opens/closes the opening. The locking means locks the rotary shutter at a closed position.

The disk cartridge is constituted as follows: accompanying insertion of the disk cartridge into the disk drive, a lock on the rotary shutter is released by lock releasing means and shutter opening means which are provided in the disk drive; and subsequently, the rotary shutter is rotated to an open position.

The disk cartridge is characterized by that the rotary shutter does not have a spring member which urges the rotary shutter to the closed position and that the rotary shutter is led to the closed position as the disk cartridge is ejected from the disk drive.

Moreover, an arcuate groove which is concentric with the rotary shutter is formed in the housing of the disk cartridge, and a shutter knob which protrudes from the arcuate groove and can be moved along the arcuate groove is attached to the rotary shutter. This shutter knob engages with an engaging wall, shutter opening means provided in the disk drive, upon insertion of the disk cartridge, and the rotary shutter is rotated to an open position.

The second invention of this application is a disk drive which includes a slot, a driving mechanism and a read/write head. A disk cartridge in which a discoid recording medium is rotatably contained in a housing is inserted into the slot. The driving mechanism rotates the recording medium to be driven. The read/write head accesses the surface of the rotating recording medium to record and reproduce information.

The housing of the disk cartridge is provided with an opening, a rotary shutter and locking means. The opening is for the read/write head to access the surface of the recording medium. The rotary shutter opens and closes the opening. The locking means locks the rotary shutter at the closed position.

The disk drive further includes lock releasing means and shutter opening means. The lock releasing means releases the rotary shutter locked by the locking means upon insertion of the disk cartridge into the disk drive. Subsequently, the shutter opening means rotates the rotary shutter to an open position.

The disk drive is characterized by that the disk drive further includes shutter closing means constituted of an elastic member. The shutter closing means engages with the rotary shutter when ejecting the disk cartridge from the disk drive. Thereafter, the shutter closing means leads the rotary shutter to the closed position.

An arcuate groove which is concentric with the rotary shutter is formed in the housing of the disk cartridge. To this rotary shutter, a shutter knob is attached. The shutter knob protrudes from the arcuate groove and can move along the arcuate groove in accordance with the rotation of the rotary shutter. The aforementioned shutter opening means can be constituted by an engaging wall which engages with the shutter knob upon insertion of the disk cartridge.

In addition, the shutter closing means made of the elastic member can be constituted as follows: the shutter closing means engages with the shutter knob upon insertion of the disk cartridge into the disk drive; moreover, the shutter closing means is bent by the shutter knob to allow the shutter knob to pass through; when ejecting the disk cartridge from the disk drive, the shutter closing means engages with the shutter knob and leads the rotary shutter to the closed position; and thereafter, the shutter closing means is bent by the shutter knob to allow the shutter knob to pass through.

The elastic member extends in a direction which is approximately orthogonal to an insertion direction of the disk cartridge. Moreover, the elastic member can be formed by a flat spring which forms a reverse V-shape as a cross section vertical to a direction the elastic member extends. This flat spring is preferably constituted to be bent so as to open the V-shape by engaging with the shutter knob to allow the shutter knob to pass through.

According to the disk cartridge of the present invention, the spring member which urges the rotary shutter to a closing direction can be removed. Thus, the guide wire becomes unnecessary, and processing for providing the spring member and the guide wire becomes unnecessary as well. Therefore, the incorporating suitability of the cartridge housing and the processability of the rotary shutter can be improved.

Incidentally, in a case where the spring member which urges the rotary shutter to the closing direction is removed, the rotary shutter stays at the open position when ejecting the disk cartridge from the disk drive. However, by providing the shutter closing means constituted of, for example, an elastic member in the disk drive, the rotary shutter (shutter knob) engages with the elastic member upon ejection. Accordingly, the slightly bent elastic member rotates the rotary shutter, on which the urging force of the spring member is not acting, to the closed position, and the rotary shutter is locked by the shutter locking means at the closed position.

Thereafter, at the final step of ejection, the elastic member is bent by the shutter knob of the rotary shutter which is locked at the closed position. Thus, the shutter knob is allowed to pass through, and the disk cartridge can be ejected.

Meanwhile, when inserting the disk cartridge into the disk drive, the shutter knob is engaged with the shutter closing means before the lock releasing means releases the lock on the rotary shutter at the closed position, owing to a positional relationship between the lock releasing means and the shutter closing means. In this case, the shutter closing means constituted of the elastic member is bent to allow the shutter knob to pass through. Thus, at this point, the shutter knob is engaged with the shutter opening means while the lock on the rotary shutter is released by the lock releasing means, and the rotary shutter is rotated to the open position.

Moreover, when inserting the disk cartridge into the disk drive, the rotary shutter locked at the closed position is released by the lock releasing means. Thereafter, when the shutter knob engages with the elastic member, the shutter closing means, the urging force does not act on the rotary shutter at all. Thus, the slightly bent elastic member rotates the rotary shutter to the open position. Subsequently, the elastic member is bent to allow the shutter knob to pass through, and the shutter knob engages with the shutter opening means.

Therefore, according to the disk drive of the present invention, the disk drive does not only function as a disk drive for the disk cartridge of the present invention, but also suits the conventional disk cartridge by simply adding the shutter closing means constituted of the elastic member to the conventional disk drive shown in FIG. 9.

### BRIEF DESCRIPTION OF THE DRAWINGS

FIGS. 1(a) and 1(b) are plan views showing a magnetic disk cartridge of the present invention when a rotary shutter is closed and opened by removing an upper shell and omitting a magnetic disk, respectively.

FIG. 2 is a plan view showing a disk drive of the present invention.

FIGS. 3(a) to 3(d) are sectional views illustrating sequential operations of an elastic member when the magnetic disk cartridge shown in FIG. 1 is inserted into/ejected from the disk drive shown in FIG. 2.

FIGS. 4(a) to 4(c) are plan views illustrating operations of a shutter knob when the magnetic disk cartridge shown in FIG. 1 is inserted into/ejected from the disk drive shown in FIG. 2.

FIGS. 5(a) to 5(d) are plan views illustrating operations of the shutter knob when the magnetic disk cartridge is inserted into/ejected from the disk drive in a different manner from FIG. 4.

FIGS. 6(a) to 6(c) are a plan view, a right side view and a bottom plan view showing a conventional magnetic disk cartridge when the rotary shutter is closed, respectively.

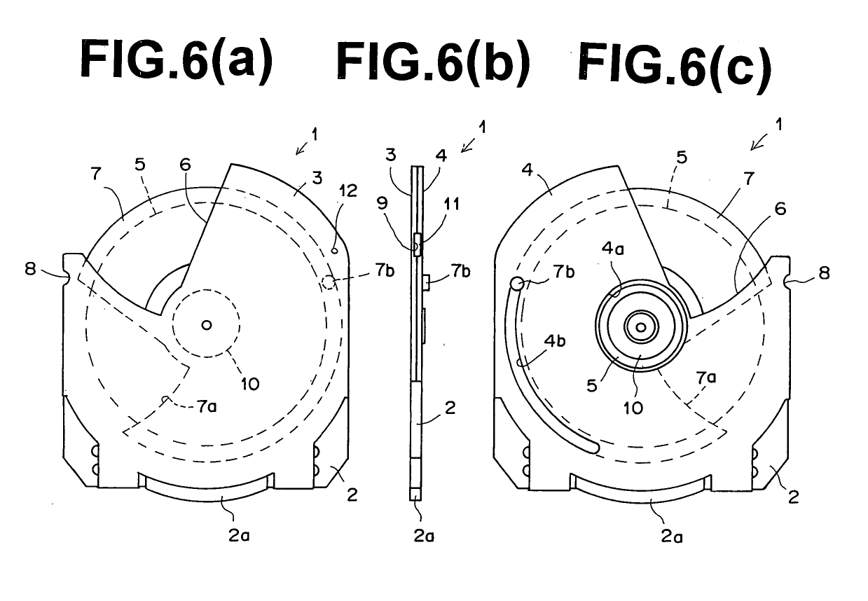

FIGS. 7(a) and 7(b) are a plan view and a bottom plan view showing the conventional magnetic disk cartridge when the rotary shutter is opened, respectively.

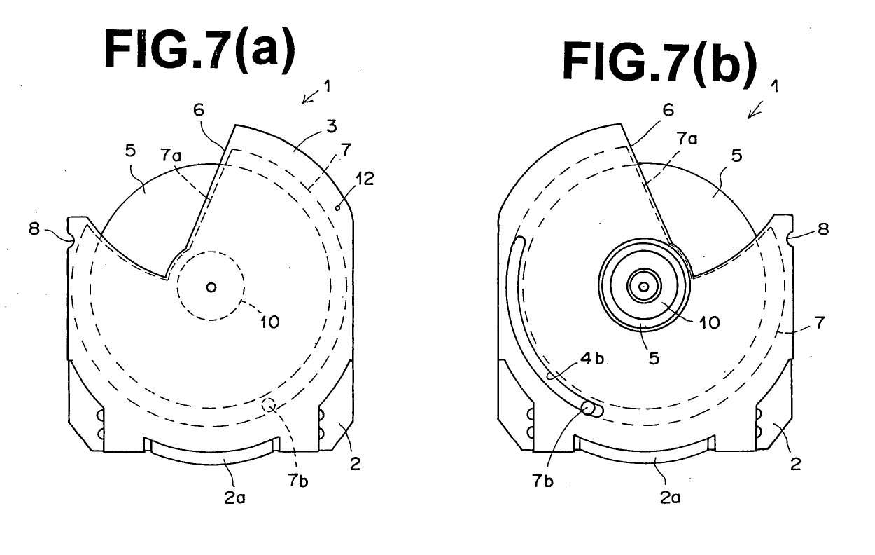

FIGS. 8(a) and 8(b) are plan views showing the conventional magnetic disk cartridge when the rotary shutter is closed and opened by removing the upper shell and omitting the magnetic disk, respectively.

FIG. 9 is a plan view showing a conventional disk drive.

### DESCRIPTION OF THE PREFERRED EMBODIMENT

An embodiment of the present invention is detailed below with reference to the attached drawings.

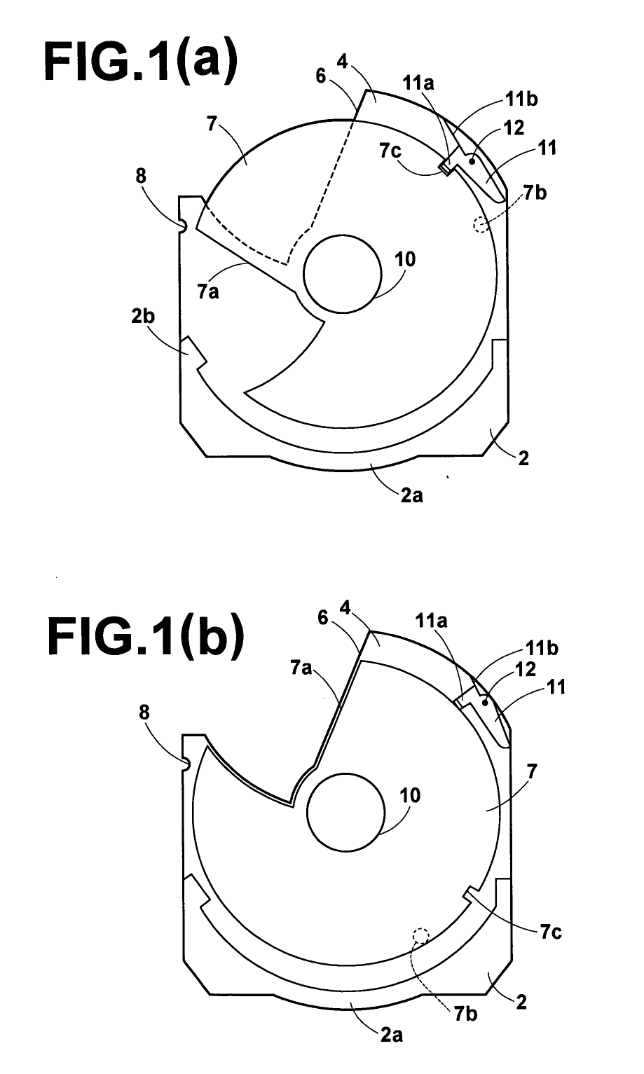

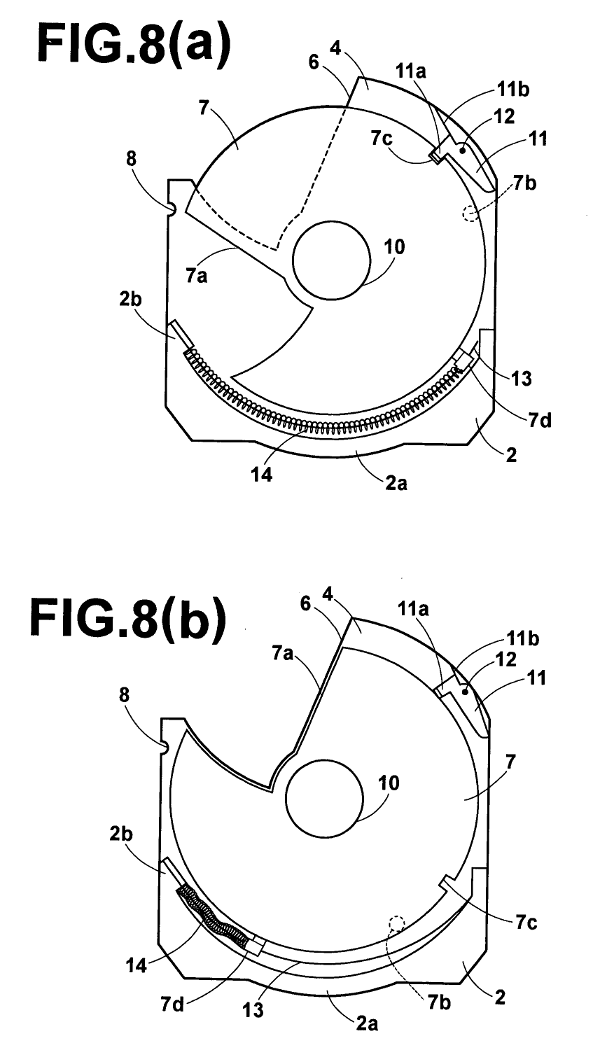

FIGS. 1(a) and 1(b) are plan views showing a magnetic disk cartridge of the present invention by contrasting with FIGS. 8(a) and 8(b), respectively. FIG. 1(a) shows a closed rotary shutter 7, and FIG. 1(b) shows the open rotary shutter 7. Both FIGS. 1(a) and 1(b) show the rotary shutter 7 by removing an upper shell 3 and omitting a magnetic disk 5.

Other than the removal of a coil spring 14 and a guide wire 13, a cartridge of the embodiment of the present invention shown in FIGS. 1(a) and 1(b) has the same structure as a conventional cartridge shown in FIGS. 8(a) and 8(b). Thus, the same reference numerals are used for the corresponding parts, and redundant descriptions are omitted.

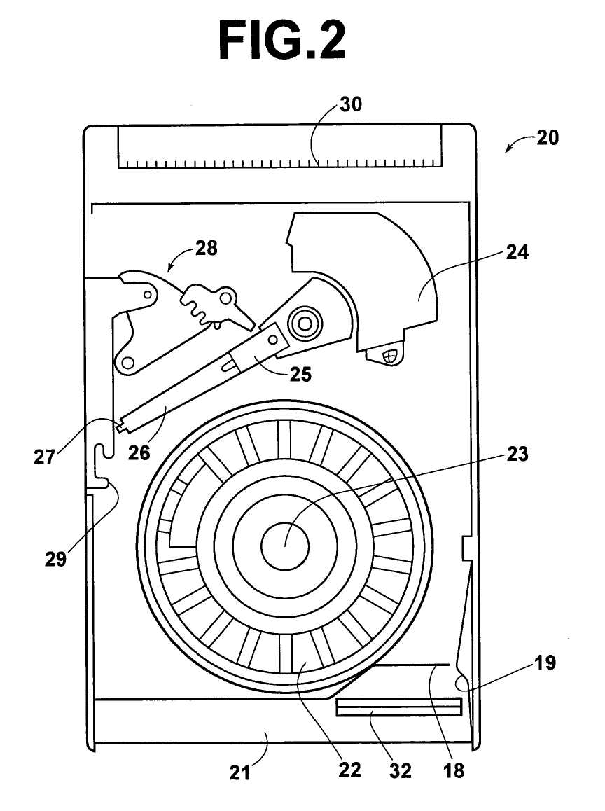

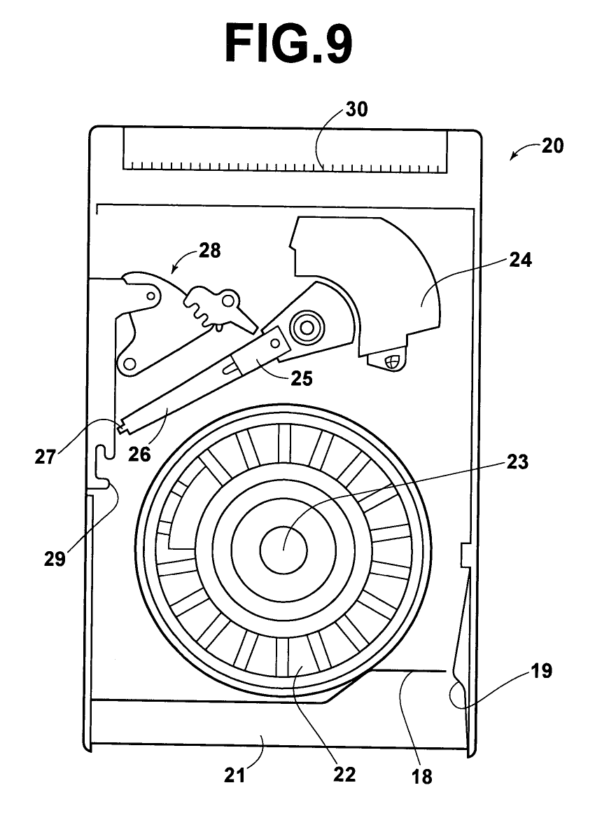

FIG. 2 is a plan view showing a disk drive 20 of the embodiment of the present invention to contrast with a conventional disk drive 20 shown in FIG. 9. The only difference between the disk drive in FIG. 2 and a conventional disk drive shown in FIG. 9 is that an elastic member 32 which serves as shutter closing means is added to the disk drive in FIG. 2. Thus, similar to the magnetic disk cartridge 1, the same reference numerals are used for corresponding parts, and redundant descriptions are omitted.

The elastic member 32 extends in a direction which is approximately orthogonal to an insertion direction of the magnetic disk cartridge 1. Moreover, the elastic member 32 is constituted of a flat spring which forms a reverse V-shape at a cross section vertical to the direction the elastic member 32 extends, and disposed in parallel with an engaging wall 18 before the engaging wall 18 and a lock releasing member 19 which are shutter opening means.

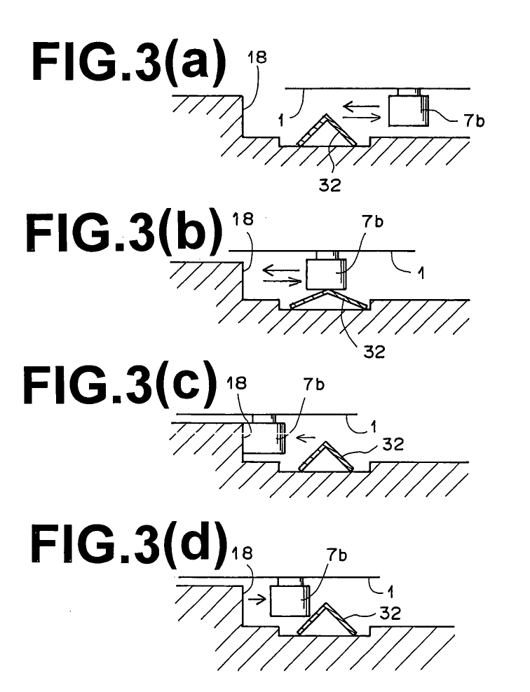

FIGS. 3(a) to 3(d) are sectional views illustrating sequential operations of the elastic member 32 when the magnetic disk cartridge 1 shown in FIG. 1 is inserted into/ejected from the disk drive 20 shown in FIG. 2.

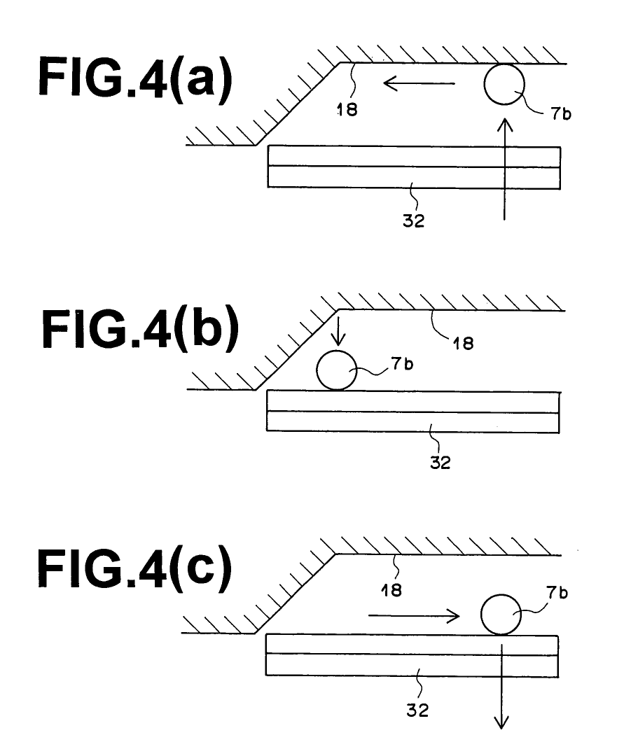

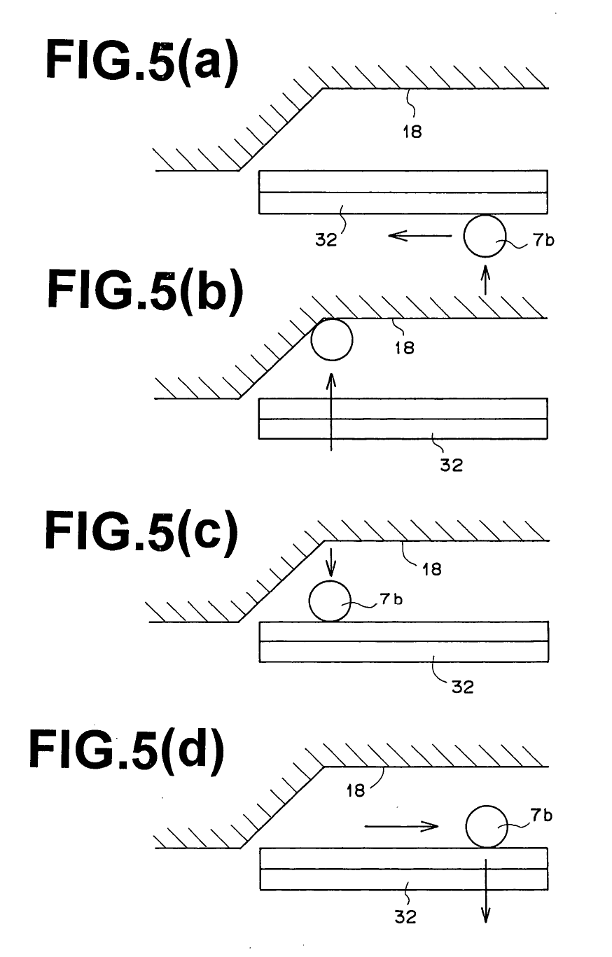

FIGS. 4(a) to 4(c) and FIGS. 5(a) to 5(d) are plan views illustrating operations of the shutter knob 7b against the engaging wall 18 and the elastic member 32 upon insertion and ejection, respectively. Note that FIGS. 4(b) and 4(c) illustrating the operation of ejection are the same as FIGS. 5(c) and 5(d), respectively.

First, when inserting the magnetic disk cartridge 1 into a slot 21 of the disk drive 20, the shutter knob 7b advances toward the elastic member 32 to engage with the elastic member 32 as shown in FIG. 3(a). At this time, if a lock on the rotary shutter 7 is not released by the lock releasing member 19, the elastic member 32 is bent so as to open in a V-shape as shown in FIG. 3(b) and allows the shutter knob 7b to pass through at a position shown in FIG. 4(a). Thereafter, the lock on the rotary shutter 7 is released by pressing a shutter locking member 11 with a lock releasing member 19. At this point, the shutter knob 7b engages with the engaging wall 18 which is the shutter opening means as shown in FIG. 3(c) and FIG. 4(a) while the lock on the rotary shutter 7 is released. Accordingly, the rotary shutter 7 is rotated to the open position as the magnetic disk cartridge 1 is further inserted. Moreover, the shutter knob 7b is moved left in the diagram along the engaging wall 18.

The maximum open degree of the rotary shutter 7 is defined by that at which the shutter knob 7b abuts on the end of the arcuate groove 4b on the lower shell 4.

Meanwhile, when inserting the magnetic disk cartridge 1 into the disk drive 20, the lock releasing member 19 presses the shutter locking member 11 to release the lock on the rotary shutter 7. Thereafter, when the shutter knob 7b engages with the elastic ring 32, the urging force of the rotary shutter 7 does not act on the rotary shutter 7 at all. Thus, the slightly bent elastic member 32 rotates the rotary shutter 7 to the open position, and the shutter knob 7b moves left in the diagram along the elastic member 32 as shown in FIG. 5(a).

Second, the elastic member 32 is bent as shown in FIG. 3(b), thereby allowing the shutter knob 7b to pass through at the position shown in FIG. 5(b). At the same time, the shutter knob 7b engages with the engaging wall 18 as shown in FIG. 3(c) and FIG. 5(b).

When ejecting the magnetic disk cartridge 1 from the disk drive 20, the shutter knob 7b engages with the elastic member from the opposite side of the insertion as shown in FIG. 3(d) at a position shown in FIG. 4(b) and FIG. 5(c). Accordingly, the rotary shutter 7 is rotated to the closed position, and the shutter knob 7b moves right in the diagram along the elastic member 32 as shown in FIG. 4(c) and FIG. 5(d). Thus, the rotary shutter 7 is locked by the shutter locking member 11 at the closed position. Therefore, upon further ejection of the magnetic disk cartridge 1, the elastic member 32 is bent by the shutter knob 7b as shown in FIG. 3(b) since the rotary shutter 7 is locked. Consequently, the shutter knob 7b is allowed to pass through at the position shown in FIG. 4(c) and FIG. 5(d), and the magnetic disk cartridge 1 can be removed.

As apparent from the above explanation, according to the magnetic disk cartridge 1 of the present embodiment, it is possible to remove the coil spring 14 which urges the rotary shutter 7 to the closing direction. The guide wire 13 becomes unnecessary, and processing for providing the coil spring 14 and the guide wire 13 becomes unnecessary as well. Therefore, the incorporating suitability of the cartridge housing and the processability of the rotary shutter 7 can be improved.

Moreover, since the elastic member 32 serving as shutter closing member is provided in the disk drive 20, the rotary shutter 7 can be securely locked at the closed position as the magnetic disk cartridge 1 is ejected from the disk drive 20 although the coil spring 14 has been removed.

Note that the present embodiment describes a magnetic disk cartridge which employs a magnetic disk as a recording medium. However, the present invention is not limited to this. The present invention can be applied to a disk cartridge provided with other types of recording media.

What is claimed is:

1. A disk cartridge in which a discoid recording medium is rotatably contained in a housing and which is inserted into a slot formed in a disk drive to be placed in the disk drive,
wherein the housing includes an opening for a read/write head of the disk drive to access a surface of the recording medium, a rotary shutter for opening/closing the opening, and shutter locking means for locking the rotary shutter at a closed position,
the rotary shutter is constituted so that a lock on the rotary shutter is released by lock releasing means and shutter opening means provided in the disk drive when inserting the disk cartridge into the disk drive, and the rotary shutter is rotated to an open position, and
the rotary shutter is constituted to be led to the closed position when ejecting the disk cartridge from the disk drive by the force of ejection.

2. The disk cartridge according to claim 1,
wherein the shutter locking means comprises:
a shutter locking member having a convex engaging portion which can engage with a concave engaging portion formed on a periphery of the rotary shutter, and rotatably provided between a shutter locking position where the convex engaging portion engages with the concave engaging portion and a lock releasing position where the convex engaging portion is escaped from the concave engaging portion in the housing; and
a spring member which urges the shutter locking member toward the shutter locking position.

3. The disk cartridge according to claim 2,
wherein the lock releasing means provided in the disk drive is constituted of a lock releasing member which engages with the shutter locking member when inserting the disk cartridge into the disk drive and rotates the shutter locking member from the shutter locking position to the lock releasing position by resisting urging force of the spring member.

4. The disk cartridge according to claim 3,
wherein an arcuate groove which is concentric with the rotary shutter is formed in the housing of the disk cartridge, and a shutter knob which protrudes from the arcuate groove and can move along the arcuate groove is attached to the rotary shutter, and
the shutter opening means provided in the disk drive is constituted of an engaging wall which engages with the shutter knob of the rotary shutter released by the lock releasing means when inserting the disk cartridge into the disk drive and rotates the rotary shutter to the open position.

5. A disk drive including a slot to which a disk cartridge in which a discoid recording medium is rotatably contained in a housing is inserted, a driving mechanism which rotates the recording medium to be driven, and a read/write head which accesses a surface of the rotating recording medium to record/reproduce information,
wherein the housing of the disk cartridge is provided with an opening for the read/write head to access the surface of the recording medium, a rotary shutter for opening/closing the opening, and shutter locking means for locking the rotary shutter at a closed position,
the disk drive further includes lock releasing means for releasing a lock on the rotary shutter by the shutter locking means when inserting the disk cartridge into the disk drive, and shutter opening means for rotating the rotary shutter to an open position, and
the disk drive still further includes shutter closing means for leading the rotary shutter to the closed position by engaging with the rotary shutter when ejecting the disk cartridge from the disk drive.

6. The disk drive according to claim 5,
wherein the shutter closing means is constituted of an elastic member.

7. The disk drive according to claim 5,
wherein the shutter locking means provided in the disk cartridge comprises:
a shutter locking member having a convex engaging portion which can engage with a concave engaging portion formed on a periphery of the rotary shutter, and rotatably provided between a shutter locking position where the convex engaging portion engages with the concave engaging portion and a lock releasing position where the convex engaging portion is escaped from the concave engaging portion in the housing; and
a spring member which urges the shutter locking member toward the shutter locking position.

8. The disk drive according to claim 7,
wherein the lock releasing means is constituted of a lock releasing member which engages with the shutter locking member when inserting the disk cartridge into the disk drive and rotates the shutter locking member from the shutter locking position to the lock releasing position while resisting urging force of the spring member.

9. The disk drive according to claim 8,
wherein an arcuate groove which is concentric with the rotary shutter is formed in the housing of the disk cartridge, and a shutter knob which protrudes from the arcuate groove and can move along the arcuate groove is attached to the rotary shutter, and
the shutter opening means is constituted of an engaging wall which engages with the shutter knob of the rotary shutter released by the lock releasing means when inserting the disk cartridge into the disk drive and rotates the rotary shutter to the open position.

10. The disk drive according to claim 9,
wherein the shutter closing means is constituted of an elastic member which is engaged with the shutter knob and bent by the shutter knob to allow the shutter knob to pass through when inserting the disk cartridge into the disk drive, engaged with the shutter knob to lead the rotary shutter to a closed position to be locked by the shutter locking member when ejecting the disk cartridge from the disk drive, and bent by the shutter knob to allow the shutter knob to pass through.

11. The disk drive according to claim 10,
wherein the elastic member is extended in a direction which is orthogonal to an insertion direction of the disk cartridge into the disk drive, constituted of a flat spring which forms a reverse V-shape at a cross section vertical to a direction which the elastic member extends, and bent so as to open the V shape by engaging with the shutter knob to allow the shutter knob to pass through.
